(19) United States
(12) Patent Application Publication
(10) Pub. No.: US 2010/0112347 A1
(43) Pub. Date: May 6, 2010

(54) PRESSURE SENSITIVE ADHESIVE FOR SUNLIGHT SHIELDING FILMS AND SUNLIGHT SHIELDING FILM

(76) Inventors: Takashi Matsushita, Kitakatsushika-gun (JP); Atsuhiro Tanaka, Toyonaka-shi (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/450,404

(22) PCT Filed: Mar. 19, 2008
(86) PCT No.: PCT/JP2008/055813

§ 371 Date: Nov. 23, 2009

(30) Foreign Application Priority Data
Mar. 30, 2007 (JP) 2007-092394

(51) Int. Cl. B32B 27/30; C08K 5/3492

(52) U.S. Cl. 428/354; 524/100

(57) ABSTRACT

A pressure sensitive adhesive for sunlight shielding films which comprises (A) a (meth)acrylic acid ester-based copolymer having carboxyl group as the crosslinking functional group, (B) a metal chelate-based crosslinking agent and (C) a triazine-based agent for absorbing ultraviolet light; and a sunlight shielding film which comprises a hard coat layer on one face of a substrate film and a pressure sensitive adhesive layer which comprises the pressure sensitive adhesive described above on the other face of the substrate film. The sunlight shielding film which comprises the above pressure sensitive adhesive exhibits excellent ultraviolet light shielding property, suppresses peeling off when the film is attached to glass having curved surfaces, exhibits excellent scratch resistance and is advantageously used for attaching to window panes of buildings and window glasses of vehicles and, in particular, to window glasses of automobiles.

### TECHNICAL FIELD

The present invention relates to a pressure sensitive adhesive for sunlight shielding films and a sunlight shielding film using the adhesive. More particularly, the present invention relates to a pressure sensitive adhesive providing a sunlight shielding film which exhibits excellent ultraviolet light shielding property, suppresses peeling off when the film is attached to glass having curved surfaces, exhibits excellent scratch resistance and is advantageously used for attaching to window panes of buildings and window glasses of vehicles and, in particular, to window glasses of automobiles and a sunlight shielding film which comprises a pressure sensitive adhesive layer formed by using the pressure sensitive adhesive and exhibits the advantageous properties described above.

### BACKGROUND ART

Open portions such as windows of buildings, vehicles, cooled showcases and refrigerated showcases have heretofore been constituted with transparent glass plates or resin plates so that sunlight can be transmitted. However, the sunlight contains ultraviolet light and near infrared light in addition to visible light.

Ultraviolet light contained in the sunlight causes sunburn, and adverse effects on the human body are pointed out. It is also well known that deterioration of contents in packages takes place due to degradation of packaging materials with ultraviolet light. Near infrared light contained in the sunlight causes problems in that the temperature at the inside of rooms is elevated due to direct rays of the sunlight, and the efficiency of cooling during the summer is decreased. Therefore, sunlight shielding films for shielding from ultraviolet light and near infrared light are attached to window panes of buildings and window glasses of vehicles so that the above undesirable effects can be prevented.

To provide advantageous properties such as scratch resistance to a sunlight shielding film, in general, the sunlight shielding film has on the surface thereof a hard coat layer obtained by coating the surface with a compound of the active energy ray curing type such as a polyester acrylate-based compound, an epoxy acrylate-based compound, a urethane acrylate-based compound, a polyol acrylate-based prepolymer and a polyfunctional monomer, followed by curing the formed coating layer.

Glass for windows of automobiles has a problem in that the surface is uneven due to black prints made of ceramics in peripheral portions and prints of heating wires for preventing fogging in central portions, and adhesion using pressure sensitive adhesives is not easy. Pressure sensitive adhesives using a metal chelate-based crosslinking agent as the crosslinking agent have been used frequently for sunlight shielding films due to the excellent property of following uneven surfaces (for example, refer to Patent Reference 1).

However, the metal chelate-based crosslinking agent has a problem in that, since the crosslinking agent reacts with agents for absorbing ultraviolet light such as benzophenone-based agents for absorbing ultraviolet light and benzotriazole-based agents for absorbing ultraviolet light which are contained in the pressure sensitive adhesive layer to provide the function of shielding from ultraviolet light to the sunlight shielding film for window glasses, the crosslinking becomes insufficient due to the reaction, and the holding power of the pressure sensitive adhesive layer is decreased. Since the sunlight shielding film for automobiles is attached to concave face of the window glass, it becomes difficult that the film is held at the attached position when the holding power is decreased, and the film is peeled off. In particular, since the glass is heated to a high temperature of about 80° C. during the summer, the holding power is further decreased, and the film tends to be peeled off further. The metal chelate-based crosslinking agent has another problem in that the crosslinking agent form a complex compound with the agent for absorbing ultraviolet light, and yellowing takes place.

Although cyanoacrylate-based agents for absorbing ultraviolet light do not react with the metal chelate-based crosslinking agent, the cyanoacrylate-based agents for absorbing ultraviolet light have a drawback in that the function of shielding from ultraviolet light is poor due to the insufficient ability of absorbing ultraviolet light.

[Patent Reference 1] Japanese Patent Application Laid-Open No. Heisei 11 (1999)-116910 (page 4, Examples)

### DISCLOSURE OF THE INVENTION

### Problems to be Overcome by the Invention

Under the above circumstances, the present invention has an object of providing a pressure sensitive adhesive providing a sunlight shielding film which exhibits excellent ultraviolet light shielding property, suppresses peeling off when the film is attached to glass having curved surfaces, exhibits excellent scratch resistance and is advantageously used for attaching to window panes of buildings and window glasses of vehicles and, in particular, to window glasses of automobiles and a sunlight shielding film which comprises a pressure sensitive adhesive layer formed by using the pressure sensitive adhesive and exhibits the advantageous properties described above.

### Means for Overcoming the Problems

As the result of intensive studies by the present inventor to achieve the above object, it was found that the above object could be achieved with a pressure sensitive adhesive which comprises a (meth)acrylic acid ester-based copolymer having carboxyl group as the crosslinking functional group, a metal chelate-based crosslinking agent and a triazine-based agent for absorbing ultraviolet light, wherein the (meth)acrylic acid ester-based copolymer is crosslinked with the metal chelate-based crosslinking agent. The present invention has been completed based on the knowledge.

The present invention provides:

[1] A pressure sensitive adhesive for sunlight shielding films which comprises (A) a (meth)acrylic acid ester-based copolymer having carboxyl group as a crosslinking functional group, (B) a metal chelate-based crosslinking agent and (C) a triazine-based agent for absorbing ultraviolet light;
[2] The pressure sensitive adhesive for sunlight shielding films described in [1], wherein a content of Component (B) is 0.01 to 3 parts by mass based on 100 parts by mass of Component (A);
[3] The pressure sensitive adhesive for sunlight shielding films described in any one of [1] and [2], wherein the triazine-based agent for absorbing ultraviolet light of Component (C) is a compound which is a 1,3,5-triazine compound having three phenyl groups, which may have substituents, introduced at 2-, 4- and 6-positions, and has a structure such that at least one of the three phenyl groups has hydroxyl group at 2-position and hydroxyl group or an organic group bonded via oxygen atom at 4-position;
[4] The pressure sensitive adhesive for sunlight shielding films described in any one of [1] to [3], wherein a content of the triazine-based agent for absorbing ultraviolet light of Component (C) is 0.1 to 30 parts by mass based on 100 parts by mass of Component (A);
[5] A sunlight shielding film which comprises a hard coat layer disposed on one face of a substrate film and a pressure sensitive adhesive layer which comprises the pressure sensitive adhesive described in any one of [1] to [4] disposed on an other face of the substrate film;
[6] The sunlight shielding film described in [5], wherein the hard coat layer is formed by using a material for forming a hard coat layer comprising a compound of an active energy ray curing type;
[7] The sunlight shielding film described in any one of [5] and [6], wherein the hard coat layer has a function of shielding from near infrared light; and
[8] The sunlight shielding film described in any one of [5] to [7], which is attached to glass having curved surfaces.

### THE EFFECT OF THE INVENTION

In accordance with present invention, the pressure sensitive adhesive providing a sunlight shielding film which exhibits excellent ultraviolet light shielding property, suppresses peeling off when the film is attached to glass having curved surfaces, exhibits excellent scratch resistance and is advantageously used for attaching to window panes of buildings and window glasses of vehicles and, in particular, to window glasses of automobiles and the sunlight shielding film which comprises a pressure sensitive adhesive layer formed by using the pressure sensitive adhesive and exhibits the advantageous properties described above are provided.

### THE MOST PREFERRED EMBODIMENT TO CARRY OUT THE INVENTION

The pressure sensitive adhesive for sunlight shielding films of the present invention (hereinafter, referred to simply as the pressure sensitive adhesive, occasionally) will be described in the following.

### [Pressure Sensitive Adhesive]

The pressure sensitive adhesive for sunlight shielding films of the present invention comprises (A) a (meth)acrylic acid ester-based copolymer having carboxyl group as the crosslinking functional group, (B) a metal chelate-based crosslinking agent and (C) a triazine-based agent for absorbing ultraviolet light, and is used for the pressure sensitive adhesive layer in sunlight shielding films.

In the present invention, a “(meth)acrylic acid ester” means both of an “acrylic acid ester” and a “methacrylic acid ester”. Similar other expressions mean similarly.

### ((Meth)Acrylic Acid Ester-Based Copolymer)

In the pressure sensitive adhesive of the present invention, the (meth)acrylic acid ester-based copolymer used as Component (A) is not particularly limited as long as the copolymer comprises carboxyl group as the crosslinking functional group, and a desired compound can be suitably selected from (meth)acrylic acid ester-based copolymers conventionally used as a resin component of pressure sensitive adhesives.

As the (meth)acrylic acid ester-based copolymer having carboxyl group as the crosslinking functional group, copolymers of a (meth)acrylic acid ester in which the alkyl group in the ester portion has 1 to 20 carbon atoms, a monomer having carboxyl group and other monomers used where desired are preferable.

Examples of the (meth)acrylic acid ester in which the alkyl group in the ester portion has 1 to 20 carbon atoms include methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, isooctyl (meth)acrylate, decyl (meth)acrylate, dodecyl (meth)acrylate, myristyl (meth)acrylate, palmityl (meth)acrylate and stearyl (meth)acrylate. The (meth)acrylic acid ester may be used singly or in combination of two or more.

Examples of the monomer having carboxyl group include ethylenically unsaturated carboxylic acids such as acrylic acid, methacrylic acid, crotonic acid, maleic acid, itaconic acid and citraconic acid. The above monomer may be used singly or in combination of two or more.

Monomers having functional groups other than carboxyl group may be used in combination with the monomer having carboxyl group where desired as long as the effect of the present invention is not adversely affected.

Examples of the monomer having functional groups other than carboxyl group include hydroxyalkyl (meth)acrylates such as 2-hydroxyethyl (methacrylate, 2-hydroxypropyl (meth)acrylate, 3-hydroxypropyl (meth)acrylate, 2-hydroxybutyl (meth)acrylate, 3-hydroxybutyl (meth)acrylate and 4-hydroxybutyl (meth)acrylate; and monoalkylaminoalkyl (meth)acrylates such as monomethylaminoethyl (meth)acrylate, monoethylaminoethyl (meth)acrylate, monomethylamino-propyl (meth)acrylate and monoethylaminopropyl (meth)acrylate. The above monomer may be used singly or in combination of two or more.

Further examples of the monomer having functional groups other than carboxyl group which are used where desired include vinyl esters such as vinyl acetate and vinyl propionate; olefins such as ethylene, propylene and isobutylene; halogenated olefins such as vinyl chloride and vinylidene chloride; styrene-based monomers such as styrene and α-methylstyrene; diene-based monomers such as butadiene, isoprene and chloroprene; nitrile-based monomers such as acrylonitrile and methacrylonitrile; and N,N-dialkyl-substituted acrylamides such as N,N-dimethylacrylamide and N,N-dimethylmethacrylamide. The above monomer may be used singly or in combination of two or more.

In the pressure sensitive adhesive of the present invention, the (meth)acrylic acid ester-based copolymer having carboxyl group as the crosslinking functional group is used from the standpoint of the reactivity since the metal chelate-based crosslinking agent is used as the crosslinking agent. The content of the monomer unit having carboxyl group (the ethylenically unsaturated carboxylic acid) in the above (meth)acrylic acid ester-based copolymer is, in general, about 0.1 to 20% by mass and preferably 1 to 10% by mass although the amount is varied depending on the type of the monomer.

The copolymer form of the (meth)acrylic acid ester-based copolymer is not particularly limited and may be any of a random copolymer, a block copolymer or a graft copolymer. It is preferable that the molecular weight is in the range of 300,000 to 2,500,00 as the mass-average molecular weight. When the mass-average molecular weight is smaller than 300,000, there is the possibility that adhesion with the adherent and durability of the adhesion are insufficient. When the mass-average molecular weight exceeds 2,500,000, there is the possibility that the property suitable for coating deteriorates. When the adhesion with the adherent, the durability of the adhesion and the property suitable for coating are considered, it is preferable that the mass-average molecular weight is 300,000 to 2,000,000 and more preferably 500,000 to 1,000,000.

The mass-average molecular weight described above is the value obtained by the measurement of the gel permeation chromatography (GPC) and expressed as the value of the corresponding polystyrene.

In the present invention, the (meth)acrylic acid ester-based copolymer may be used singly or in combination of two or more. Where desired, the (meth)acrylic acid ester-based copolymer having a great molecular weight may be used in combination with (meth)acrylic acid ester-based homopolymers or copolymers having a small molecular weight such as a mass-average molecular weight of 100,000 or smaller.

### (Metal Chelate-Based Crosslinking Agent)

In the pressure sensitive adhesive of the present invention, a metal chelate-based crosslinking agent is used as the crosslinking agent of Component (B). Due to the metal chelate-based crosslinking agent, the pressure sensitive adhesive in which the (meth)acrylic acid ester-based copolymer of Component (A) is crosslinked with the metal chelate-based crosslinking agent exhibits excellent property of following uneven surfaces and can be advantageously used for sunlight shielding films such as the film attached to window glasses of automobiles.

The metal chelate-based crosslinking agent is not particularly limited and can be suitably selected from compounds conventionally used as the metal chelate-based crosslinking agent in pressure sensitive adhesives. As the metal chelate-based crosslinking agent, chelate compounds having a metal atom such as aluminum, zirconium, titanium, zinc, iron and tin are used. Aluminum chelate compounds are preferable from the standpoint of the properties.

Examples of the aluminum chelate compound include diisopropoxyaluminum monooleyl acetoacetate, monoisopropoxyaluminum bisoleyl acetoacetate, monoisopropoxyaluminum monooleate monoethyl acetoacetate, diisopropoxyaluminum monolauryl acetoacetate, diisopropoxyaluminum monostearyl acetoacetate, diisopropoxyaluminum monoisostearyl acetoacetate, monoisopropoxyaluminum mono-N-lauroyl-β-alanate monolauryl acetoacetate, aluminum trisacetylacetonate, monoacetylacetonatoaluminum bis(isobutyl acetoacetate) chelate, monoacetylacetonatoaluminum bis(2-ethylhexylacetoacetate) chelate, monoacetylacetonatoaluminum bis(dodecyl acetoacetate) chelate and monoacetylacetonatoaluminum (bisoleyl acetoacetate) chelate.

Examples of the other metal chelate compound include titanium tetrapropionate, titanium tetra-n-butyrate, titanium tetra-2-ethyl-hexanoate, zirconium sec-butyrate, zirconium diethoxy-tert-butyrate, triethanolamine titanium dipropionate, ammonium salt of titanium lactate and tetraoctylene glycol titanate.

In the present invention, the metal chelate-based crosslinking agent may be used singly or in combination of two or more. The content is selected, in general, in the range of 0.01 to 3 parts by mass, preferably in the range of 0.02 to 2 parts by mass and more preferably in the range of 0.03 to 1 part by mass based on 100 parts by mass of the (meth)acrylic acid ester-based copolymer of Component (A) from the standpoint of the properties as the pressure sensitive adhesive.

### (Triazine-Based Agent for Absorbing Ultraviolet Light)

In the pressure sensitive adhesive of the present invention, a triazine-based agent for absorbing ultraviolet light is used as the agent for absorbing ultraviolet light of Component (C).

Heretofore, in a pressure sensitive adhesive layer in a sunlight shielding film, in general, a benzophenone-based agent for absorbing ultraviolet light or a benzotriazole-based agent for absorbing ultraviolet light is used. However, when the metal chelate-based crosslinking agent is used as the crosslinking agent, these agents for absorbing ultraviolet light react with the crosslinking agent to cause insufficient crosslinking of the pressure sensitive adhesive layer, and problems arise in that the holding power is decreased and yellowing takes place.

Therefore, a triazine-based agent for absorbing ultraviolet light which does not react with the metal chelate-based crosslinking agent is used as the agent for absorbing ultraviolet light in the present invention.

It is considered that the triazine-based agent for absorbing ultraviolet light does not react with the metal chelate-based crosslinking agent since the bonding energy of the O—H bond bonded to phenyl group is greater than that in the benzophenone-based agent for absorbing ultraviolet lights and in the benzotriazole-based agent for absorbing ultraviolet light, and abstraction of hydrogen atom is suppressed.

The triazine-based agent for absorbing ultraviolet light is not particularly limited, and at least one agent is selected as desired from conventional triazine-based agents for absorbing ultraviolet light.

In the present invention, as the triazine-based agent for absorbing ultraviolet light, a compound which is a 1,3,5-triazine compound having three phenyl groups, which may have substituents, introduced at the 2-, 4- and 6-positions and has a structure such that at least one of the three phenyl groups has hydroxyl group at the 2-position and hydroxyl group or an organic group bonded via oxygen atom at the 4-position, is preferable.

Examples of the triazine-based agent for absorbing ultraviolet light described above include compounds described, for example, in Japanese Patent Application Laid-Open Nos. Heisei 6 (1994)-211813, Heisei 8 (1996)-53427, Heisei 9 (1997)-20760 and Heisei 11 (1999)-71356 and Japanese Patent Application (as a national phase under PCT) Laid-Open Nos. 2004-513122 and 2004-533529.

The triazine-based agent for absorbing ultraviolet light can be divided into mono(hydroxyphenyl)triazine compounds, bis(hydroxy-phenyl)triazine compounds and tris(hydroxyphenyl)triazine compounds. Examples of the mono(hydroxyphenyl)triazine compound include 2-[4-[(2-hydroxy-3-dodecyloxypropyl)oxy]-2-hydroxyphenyl]-4,6-bis(2,4-dimethyl-phenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine, 2-(2,4-di-hydroxyphenyl)-4,6-bis(2,4-dimethylphenyl)-1,3,5-triazine, 2-(2-hydroxy-4-isooctyloxyphenyl)-4,6-bis(2,4-dimethylphenyl)-1,3,5-triazine and 2-(2-hydroxy-4-dodecyloxyphenyl)-4,6-bis(2,4-dimethylphenyl)-1,3,5-triazine. Examples of the bis(hydroxyphenyl)triazine compound include 2,4-bis(2-hydroxy-4-propyloxyphenyl)-6-(2,4-dimethylphenyl)-1,3,5-triazine, 2,4-bis-(2-hydroxy-3-methyl-4-propyloxyphenyl)-6-(4-methylphenyl)-1,3,5-triazine, 2,4-bis(2-hydroxy-3-methyl-4-hexyloxyphenyl)-6-(2,4-dimethylphenyl) 1,3,5-triazine and 2-phenyl-4,6-bis[2-hydroxy-4-[3-(methoxyheptaethoxy)-2-hydroxypropyloxy]phenyl]-1,3,5-triazine.

Examples of the tris(hydroxyphenyl)triazine compound include 2,4-bis(2-hydroxy-4-butoxyphenyl)-6-(2,4-dibutoxyphenyl)-1,3,5-triazine, 2,4,6-tris(2-hydroxy-4-octyloxyphenyl)-1,3,5-triazine, 2,4,6-tris[2-hydroxy-4-(3-butoxy-2-hydroxypropyloxy)phenyl]-1,3,5-triazine, 2,4-bis[2-hydroxy-4-[1-(isooctyloxycarbonyl)ethoxy]phenyl]-6-(2,4-dihydroxyphenyl)-1,3,5-triazine, 2,4,6-tris[2-hydroxy-4-[1-(isooctyloxycarbonyl)ethoxy]phenyl]-1,3,5-triazine and 2,4-bis[2-hydroxy-4-[1-(isooctyloxycarbonyl)ethoxy]-phenyl]-6-[2,4-bis[1-(isooctyloxycarbonyl)ethoxy]phenyl]-1,3,5-triazine.

In the present invention, the triazine-based agent for absorbing ultraviolet light may be used singly or in combination of two or more. Among these agents for absorbing ultraviolet light, tris(hydroxyphenyl)-triazine compounds are preferable from the standpoint of the ability of shielding from ultraviolet light.

The content of the triazine-based agent for absorbing ultraviolet light in the pressure sensitive adhesive of the present invention is, in general, 0.1 to 30 parts by mass, preferably 0.5 to 20 parts by mass and more preferably 1 to 15 parts by mass based on 100 parts by mass of the (meth)acrylic acid ester-based copolymer of Component (A) from the standpoint of the balance between the ability of shielding from ultraviolet light and the economy.

(Components Added where Desired)

Where desired, the pressure sensitive adhesive of the present invention may comprise various additive components such as silane coupling agents, antioxidants, tackifiers, crosslinking agents other than the metal chelate, fillers and leveling agents as long as the effect of the present invention is not adversely affected.

The silane coupling agent exhibits the function of increasing adhesion of the pressure sensitive adhesive to the face of glass. Examples of the silane coupling agent include triethoxysilane, vinyltris(β-methoxyethoxy)silane, γ-methacryloxypropyltrimethoxysilane, γ-glycidoxypropyltrimethoxysilane, β-(3,4-epoxycyclohexyl)ethyl-trimethoxysilane, N-β-(aminoethyl)-γ-aminopropyltrimethoxysilane, N-β-(aminoethyl)-γ-aminopropylmethyldimethoxysilane, γ-aminopropyl-triethoxysilane, N-phenyl-γ-aminopropyltrimethoxysilane, γ-mercapto-propyltrimethoxysilane and γ-chloropropyltrimethoxysilane. Among these compounds, γ-aminopropyltriethoxysilane and N-β-(aminoethyl)-γ-aminopropyltrimethoxysilane are preferable.

As the antioxidant, a conventional hindered phenol-based antioxidant may be added, or a unit exhibiting the function of antioxidation may be introduced into the molecule of the copolymer by copolymerizing a monomer having the unit exhibiting the function of antioxidation during preparation of the (meth)acrylic acid ester-based copolymer of Component (A). As the monomer having the unit exhibiting the function of antioxidation, for example, “SUMILIZER GM” and “SUMILIZER GS” [manufactured by SUMITOMO CHEMICAL Co., Ltd.] are commercially available.

The pressure sensitive adhesive of the present invention can be produced, for example, in accordance with the process shown in the following. A pressure sensitive adhesive composition (a coating fluid) comprising the (meth)acrylic acid ester-based copolymer having carboxyl group as the crosslinking functional group of Component (A), the metal chelate-based crosslinking agent of Component (B), the triazine-based agent for absorbing ultraviolet light of Component (C) and various additive components used where desired in each specific relative amount in a suitable solvent is prepared. Then, the face of a substrate film or the face treated for releasing of a release film is coated with the prepared coating fluid. The formed coating film is dried at a temperature of about 60 to 130° C. for about 30 seconds to 5 minutes, and the pressure sensitive adhesive of the present invention in which the (meth)acrylic acid ester-based copolymer of Component (A) is crosslinked with the metal chelate-based crosslinking agent of Component (B) can be obtained.

The pressure sensitive adhesive of the present invention obtained as described above exhibits the excellent property of shielding from ultraviolet light and the excellent property of following uneven surfaces and can be used as the component constituting the pressure sensitive adhesive layer in the sunlight shielding film.

The sunlight shielding film of the present invention will be described in the following.

### [Sunlight Shielding Film]

The sunlight shielding film of the present invention is a laminate film which comprises a hard coat layer disposed on one face of a substrate film and a pressure sensitive adhesive layer which comprises the pressure sensitive adhesive of the present invention described above disposed on the other face of the substrate film

### (Substrate Film)

The substrate film used for the sunlight shielding film of the present invention is not particularly limited, and a suitable film can be selected from various transparent plastic films in accordance with the situation. Examples of the transparent plastic film include films of resins, examples of which include polyolefin-based resins such as polyethylene, polypropylene, poly-4-methylpentene-1 and polybutene-1, polyester-based resins such as polyethylene terephthalate and polyethylene naphthalate, polycarbonate-based resins, polyvinyl chloride-based resins, polyphenylene sulfide-based resins, polyether sulfone-based resins, polyethylene sulfide-based resins, polyphenylene ether-based resins, styrene-based resins, acrylic resins, polyamide-based resins and cellulose-based resins such as cellulose acetate; and laminate films of these films. Among these plastic films, films of polyethylene terephthalate are preferable.

The thickness of the substrate film is not particularly limited and is suitably selected in accordance with the object of the use of the sunlight shielding film. The thickness is, in general, about 10 to 500 μm, preferably 12 to 300 μm and more preferably 16 to 125 μm.

Where desired, the substrate film may be colored, may have a film obtained by vapor deposition or may comprise anti-weathering agents such as antioxidants, agents for absorbing ultraviolet light and light stabilizers. The substrate film may be treated on one or both faces with a surface treatment such as an oxidation treatment and a roughening treatment for the purpose of improving adhesion with the layer formed on the substrate film Examples of the oxidation treatment include the treatment with corona discharge, the treatment with plasma, the treatment with chromic acid (the wet treatment), the treatment with flame, the treatment with the heated air and the treatment with ozone and irradiation with ultraviolet light. Examples of the roughening treatment include the sand blasting treatment and the treatment with solvents. The surface treatment is suitably selected in accordance with the type of the substrate film. In general, the treatment with corona discharge is preferable from the standpoint of the effect and the operability. A primer layer may be formed on the substrate film

### [Hard Coat Layer]

In the sunlight shielding film of the present invention, the type of the hard coat layer and the process for forming the hard coat layer disposed on one face of the substrate film are not particularly limited. From the standpoint of the properties and the workability as the hard coat layer, it is preferable that the hard coat layer is a layer formed by using a material for forming the hard coat layer comprising a compound of the active energy ray curing type.

In the present invention, it is preferable that the hard coat layer is provided with the function of shielding from near infrared light (heat rays) in the sunlight. When the hard coat layer is provided with the function of shielding from near infrared light, the elevation of the temperature at the inside can be suppressed and the consumption of energy is decreased by attaching the sunlight shielding film of the present invention to windows of buildings, vehicles, cooled showcases and refrigerated showcases so that.

The compound of the active energy ray curing type used for the material for forming a hard coat layer in the present invention is a compound which is crosslinked and cured by irradiation with ray having energy quantum among electromagnetic waves and charged particles such as ultraviolet light and electron beams.

Examples of the compound of the active energy ray curing type include compounds of the radical polymerization type and compounds of the cationic polymerization type. Examples of the compound of the radical polymerization type among the compound of the active energy ray curing type include prepolymers polymerizable with energy rays and monomers polymerizable with energy rays. Examples of the prepolymer polymerizable with energy rays of the radical polymerization type include polyester acrylate-based prepolymers, epoxy acrylate-based prepolymers, urethane acrylate-based prepolymers and polyol acrylate-based prepolymers. The polyester acrylate-based prepolymer can be obtained, for example, by esterification with (meth)acrylic acid of hydroxyl group in a polyester oligomer having hydroxyl group at both ends which is obtained by condensation of a polybasic carboxylic acid and a polyhydric alcohol, or by esterification with (meth)acrylic acid of hydroxyl group at the ends of an oligomer which is obtained by addition of an alkylene oxide to a polybasic carboxylic acid.

The epoxy acrylate-based prepolymer can be obtained, for example, by esterification by reaction of (meth)acrylic acid with the oxirane ring in an epoxy resin of the bisphenol type or an epoxy resin of the novolak type having a relatively small molecular weight. The urethane acrylate-based prepolymer can be obtained, for example, by esterification with (meth)acrylic acid of a polyurethane oligomer which is obtained by the reaction of a polyether polyol or a polyester polyol with a polyisocyanate. The polyol acrylate-based prepolymer can be obtained, for example, by esterification with (meth)acrylic acid of hydroxyl group in a polyether polyol. The prepolymer polymerizable with active energy ray of the radical polymerization type may be used singly or in combination of two or more.

Examples of the monomer polymerizable with active energy ray of the radical polymerization type include polyfunctional acrylates such as 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, hydroxypivalic acid neopentyl glycol di(meth)acrylate, dicyclopentanyl di(meth)acrylate, dicyclopentenyl di(meth)acrylate modified with caprolactone, phosphoric acid di(meth)acrylate modified with ethylene oxide, cyclohexyl di(meth)acrylate modified with allyl group, isocyanurate di(meth)acrylate, trimethylolpropane tri(meth)acrylate, dipentaerythritol tri(meth)acrylate, dipentaerythritol tri(meth)acrylate modified with propionic acid, pentaerythritol tri(meth)acrylate, trimethylolpropane tri(meth)acrylate modified with propylene oxide, tri(acryloxyethyl) isocyanurate, dipentaerythritol penta(meth)acrylate modified with propionic acid, dipentaerythritol hexa(meth)acrylate, dipentaerythritol hexa-(meth)acrylate modified with caprolactone and dipentaerythritol penta(meth)acrylate. The monomer polymerizable with active energy ray of the radical polymerization type may be used singly, in combination of two or more or in combination with the prepolymer polymerizable with active energy ray of the radical polymerization type.

As the prepolymer polymerizable with active energy ray of the cationic polymerization type, in general, epoxy resins are used. Examples of the epoxy resin include compounds obtained by epoxidation of polyphenols such as bisphenol resins and novolak resins with an epoxy compound such as epichlorohydrin and compounds obtained by oxidation of linear olefin compounds and cyclic olefin compounds with peroxides.

As for the material for forming a hard coat layer in the present invention, it is preferable that the hard coat layer is formed by curing with ultraviolet light when formation of damages on the substrate film and productivity are considered. In this case, in general, a photopolymerization initiator is added to the material for forming a hard coat layer.

Examples of the photopolymerization initiator used for the prepolymers polymerizable with active energy ray of the radical polymerization type and monomers polymerizable with active energy ray of the radical polymerization type include benzoin, benzoin methyl ether, benzoin ethyl ether, benzoin isopropyl ether, benzoin n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 2-hydroxy-1-[4-[4-(2-hydroxy-2-methylpropionyl)benzyl]phenyl]-2-methylpropan-1-one, 1-hydroxycyclo-hexyl phenyl ketone, 2-methyl-1-[4-(methylthio)phenyl]-2-morpholino-propan-1-one, 4-(2-hydroxyethoxy)phenyl-2-(hydroxy-2-propyl) ketone, benzophenone, p-phenylbenzophenone, 4,4′-diethylaminobenzophenone, dichlorobenzophenone, 2-methylanthraquinone, 2-ethylanthraquinone, 2-tertiary-butylanthraquinone, 2-aminoanthraquinone, 2-methylthio-xanthone, 2-ethylthioxanthone, 2-chlorothioxanthone, 2,4-dimethylthio-xanthone, 2,4-diethylthioxanthone, benzyl dimethyl ketal, acetophenone dimethyl ketal and p-dimethylamine benzoic acid ester. Examples of the photopolymerization initiator used for the prepolymers polymerizable with active energy ray of the cationic polymerization type include compounds comprising oniums such as aromatic sulfonium ions, aromatic oxosulfonium ions and aromatic iodinium ions and anions such as tetrafluoroborate, hexafluorophosphate, hexafluoroantimonate and hexafluoroarsenate. The above compound may be used singly or in combination of two or more. The amount is selected, in general, in the range of 0.2 to 10 parts by mass based on 100 parts by mass of the prepolymer polymerizable with active energy ray and/or the monomer polymerizable with active energy ray.

In the present invention, the material for forming a hard coat layer may comprise a material for absorbing near infrared light so that the function of shielding from near infrared light is provided to the hard coat layer.

The agent for absorbing near infrared light is divided into organic agent for absorbing near infrared light and inorganic agent for absorbing near infrared light. Examples of the organic agent for absorbing near infrared light include cyanine-based compounds; squalirium-based compounds; thiol nickel complex salt-based compounds; naphthalo-cyanine-based compounds; phthalocyanine-based compounds; triallylmethane-based compounds; naphthoquinone-based compounds; anthraquinone-based compounds; amino compounds such as perchloric acid salt of N,N,N′,N′-tetrakis(p-di-n-butylaminophenol)-p-phenylene-diaminium, chlorine salt of phenylenediaminium, hexafluoroantimonic acid salt of phenylenediaminium, fluoroboric acid salt of phenylene-diaminium, fluorine salt of phenylenediaminium and perchloric acid salt of phenylenediaminium; copper compounds and bisthiourea compounds; phosphorus compounds and copper compounds; and phosphoric acid ester copper compounds obtained by the reaction of phosphoric acid esters and copper compounds.

Among these compounds, thiol nickel complex salt-based compounds (Japanese Patent Application Laid-Open No. Heisei 9 (1997)-230134) and phthalocyanine-based compounds are preferable, and phthalocyanine compounds having fluorine disclosed in Japanese Patent Application Laid-Open No. 2000-26748 are more preferable due to the great transmission of visible light and excellent properties such as excellent heat resistance, light resistance and weatherability.

Examples of the inorganic agent for absorbing near infrared-light 2-5 include tungsten oxide-based compounds, titanium oxide, zirconium oxide, tantalum oxide, niobium oxide, zinc oxide, indium oxide, indium oxide doped with tin (ITO), tin oxide, tin oxide doped with antimony (ATO), cesium oxide, zinc sulfide and hexaborides such as LaB₆, CeB₆, PrB₆, NdB₆, GdB₆, TbB₆, DyB₆, HoB₆, YB₆, SmB₆, EuB₆, ErB₆, TmB₆, YbB₆, LuB₆, SrB₆, CaB₆ and (La, Ce)B₆. Among these compounds, the tungsten oxide-based compounds are preferable due to the great absorption of near infrared light and the great spectroscopic transmittance of visible light. In particular, tungsten oxide comprising cesium represented by the formula:

Cs_{0.2˜0.4}WO₃

is more preferable.

When the organic agents for absorbing near infrared light and the inorganic agents for absorbing near infrared light are compared, in general, the inorganic agents exhibit remarkably more excellent light resistance and weatherability although the organic agents exhibit more excellent ability of absorption of near infrared light. The organic agents have another drawback in that the agents tend to be colored. Therefore, inorganic agents are preferable from the standpoint of the practical use. It is more preferable that tungsten oxide comprising cesium is used. For forming a coating layer which has a small absorption in the region of the visible light and is transparent, it is preferable that this inorganic agent for absorbing near infrared light has a particle diameter of 0.5 μm or smaller and more preferably a diameter of 0.1 μm or smaller.

The inorganic agent for absorbing near infrared light described above may be used singly or in combination of two or more. The inorganic agent for absorbing near infrared light and the organic agent for absorbing near infrared light may be used in combination.

In the present invention, the material for a hard coat layer can be prepared by adding the compound of the active energy curing, type described above, the photopolymerization initiator which is used where desired, the agent absorbing near infrared light described above which is used where desired and various additives such as antioxidants, light stabilizers, antistatic agents, leveling agents and defoaming agents in each specific amount into a suitable solvent which is used where necessary, followed by dissolving or dispersing the components.

Examples of the solvent used in the above include aliphatic hydrocarbons such as hexane, heptane and cyclohexane, aromatic hydrocarbons such as toluene and xylene, halogenated hydrocarbons such as methylene chloride and ethylene chloride, alcohols such as methanol, ethanol, propanol, butanol and 1-methoxy-2-propanol, ketones such as acetone, methyl ethyl ketone, 2-pentanone, methyl isobutyl ketone and isophorone, esters such as ethyl acetate and butyl acetate and cellosolve-based solvents such as ethylcellosolve.

The concentration and the viscosity of the material for forming a hard coat layer (the coating fluid) prepared as described above are not particularly limited as long as the concentration and the viscosity allow the coating operation and can be suitably selected in accordance with the situation.

One face of the substrate film is coated with the material for forming a hard coat layer prepared as described above in accordance with a conventional process such as the bar coating process, the knife coating process, the roll coating process, the blade coating process, the die coating process and the gravure coating process to form a coating film, and the formed coating film is dried. Then, the dried coating film is irradiated with active energy ray to cure the coating film, and a hard coat layer is formed.

Examples of the active energy ray include ultraviolet light and electron beams Ultraviolet light can be obtained from a high pressure mercury lamp, a fusion electrodeless discharge lamp or a xenon lamp. Electron beams can be obtained from an electron accelerator. Among these active energy rays, ultraviolet light is preferable. When electron beams are used, the cured film can be obtained without adding the photopolymerization initiator.

In the present invention, the thickness of the hard coat layer is, in general, in the range of 1 to 10 μm. When the thickness is smaller than 1 μm, there is the possibility that the obtained sunlight shielding film does not exhibit the sufficient scratch resistance. When the thickness exceeds 10 μm, cracks are formed on the hard coat layer, occasionally. It is preferable that the thickness of the hard coat layer is in the range of 1 to 5 μm.

In the sunlight shielding film of the present invention, where necessary, an antifouling coating layer may be disposed on the hard coat layer. The antifouling coating layer can be formed, in general, by coating the hard coat layer with a coating fluid comprising a fluorine-based resin in accordance with a conventional process such as the bar coating process, the knife coating process, the roll coating process, the blade coating process, the die coating process and the gravure coating process to form a coating fluid, followed by drying the formed coating film.

The thickness of the antifouling coating film is, in general, in the range of 0.001 to 10 μm and preferably in the range of 0.01 to 5 μm. By forming the antifouling coating layer, the surface of the obtained sunlight shielding film exhibits an improved slipping property, and fouling of the surface is suppressed.

### [Pressure Sensitive Adhesive Layer]

In the sunlight shielding film of the present invention, a pressure sensitive adhesive layer which comprises the pressure sensitive adhesive of the present invention described above is disposed on the face of the substrate film opposite to the face having the hard coat layer.

The pressure sensitive adhesive layer can be formed in accordance with the process described in the following. A pressure sensitive adhesive composition (a coating fluid) comprising the components of the pressure sensitive adhesive of the present invention described above in each specific amount in a suitable solvent is prepared, the component being the (meth)acrylic acid ester-based copolymer having carboxyl group as the crosslinking group of Component (A), the metal chelate-based crosslinking agent of Component (B), the triazine-based agent for absorbing ultraviolet light of Component (C) and various additive components described above which are used where desired. The face of the substrate film opposite to the face having the hard coat layer is coated with the prepared pressure sensitive adhesive composition in accordance with the conventional process. Then, the formed coating layer is dried at a temperature of about 130° C. for about 30 seconds to 5 minutes, and a pressure sensitive adhesive layer which comprises the pressure sensitive adhesive of the present invention in which the (meth)acrylic acid ester-based copolymer of Component (A) is crosslinked with the metal chelate-based crosslinking agent of Component (B) can be formed.

The thickness of the pressure sensitive adhesive layer is, in general, in the range of 1 to 100 μm and preferably in the range of 2 to 50 μm.

In the sunlight shielding film of the present invention, a release film may be attached to the pressure sensitive adhesive film described above. Examples of the release film include release films prepared by coating a plastic film with a releasing agent. Examples of the plastic film include films of polyesters such as polyethylene terephthalate, polybutylene terephthalate and polyethylene naphthalate and polyolefins such as polypropylene and polyethylene. As the releasing agent, silicone-based release agents, fluorine-based releasing agents and long chain alkyl-based releasing agents can be used. Among these releasing agents, silicone-based releasing agents are preferable since these agents are inexpensive, and stable properties can be obtained. The thickness of the release film is not particularly limited and is, in general, about 20 to 250 μm and preferably 20 to 50 μm.

For attaching the release film to the pressure sensitive adhesive layer, the layer of the releasing agent on the release film is coated with a pressure sensitive adhesive to form a pressure sensitive adhesive layer having the prescribed thickness. The obtained laminate is attached to the face of the substrate film opposite to the face having the hard coat layer so that the pressure sensitive adhesive layer is transferred. The release film may be left being attached.

Since the sunlight shielding film of the present invention comprises the triazine-based agent for absorbing ultraviolet light and the pressure sensitive adhesive layer in which the resin component is crosslinked with the metal chelate-based crosslinking agent, the sunlight shielding film exhibits the excellent property of shielding from ultraviolet light and suppresses peeling off when the film is attached to glass having curved surfaces. The scratch resistance is excellent due to the hard coat layer disposed on the outside surface. The function of shielding from near infrared light (heat ray) can be provided by adding the agent for absorbing near infrared light into the hard coat layer.

In the sunlight shielding film of the present invention, the transmittance of ultraviolet light measured in accordance with the method of Japanese Industrial Standard S 3107 is, in general, smaller than 1%, and the yellowness index measured in accordance with the method of Japanese Industrial Standard K 7105 is, in general, smaller than 2.

The holding power measured in accordance with the method of Japanese Industrial Standard Z 0237 (the method will be described specifically below) is, in general, smaller than 1 mm at 40° C. and, in general, smaller than 2 mm at 80° C.

The sunlight shielding film of the present invention exhibiting the above properties is advantageously used for attaching to glasses of buildings and vehicles and, in particular, window glasses of automobiles.

### EXAMPLES

The present invention will be described more specifically with reference to examples in the following. However, the present invention is not limited to the examples.

The properties of the sunlight shielding films prepared in Examples and Comparative Examples were measured in accordance with the following methods.

### (1) Holding Power

The holding power was measured at 40° C. and 80° C. in accordance with the method of Japanese Industrial Standard Z 0237 as described in the following.

A sample having a size of 25 mm×25 mm was attached to a stainless steel plate. Under a dry atmosphere at 40° C. and a dry atmosphere at 80° C., a weight having a mass of 1 kg was suspended from the sample, and the distance of the shift of the position of the sample or the time before the sample and the weight dropped was measured. The smaller the distance, the greater the holding power.

### (2) Transmittance of Ultraviolet Light

The transmittance of ultraviolet light was measured in accordance with the method of Japanese Industrial Standard S 3107. The transmittance was satisfactory when the value was smaller than 1%.

### (3) Yellowness Index

The transmittance was measured in accordance with the method of Japanese Industrial Standard K 7105. The yellowness index was satisfactory when the value was smaller than 2 since yellowness could be observed with the naked eye when the value was 2 or greater.

### Example 1

### (1) Preparation of a Pressure Sensitive Adhesive Composition

An ethyl acetate solution containing an acrylic acid ester copolymer having carboxyl group (the mass-average molecular weight: 600,000) in a concentration of 33% by mass was obtained by radical polymerization of 75% by mass of 2-ethylhexyl acrylate, 23% by mass of vinyl acetate and 2% by mass of acrylic acid. To 100 parts by mass of the ethyl acetate solution obtained above, 0.5 parts by mass of an aluminum chelate compound [manufactured by SOKEN CHEMICAL AND ENGINEERING Co., Ltd.; “M-5A”; aluminum trisacetylacetonate; the content of solid components: 4.95% by mass] and 4.0 parts by mass of an agent for absorbing ultraviolet light [manufactured by CIBA SPECIALTY CHEMICALS Co., Ltd.; “CGL 777 MPAD”; a tris(hydroxyphenyl)triazine compound; the content of solid components: 80% by mass] were added, and a pressure sensitive adhesive composition was prepared.

“CGL 777 MPAD” described above is a mixture of 2,4-bis[2-hydroxy-4-[1-(isooctyloxycarbonyl)ethoxy]phenyl]-6-(2,4-dihydroxyphenyl)-1,3,5-triazine expressed by the following formula (a), 2,4,6-tris[2-hydroxy-4-[1-(isooctyloxycarbonyl)ethoxy]phenyl]-1,3,5-triazine expressed by the following formula (b) and 2,4-bis[2-hydroxy-4-[1-(isooctyloxy-carbonyl)ethoxy]phenyl]-6-[2,4-bis[1 isooctyloxycarbonyl)ethoxy]phenyl]-1,3,5-triazine expressed by the following formula (c).

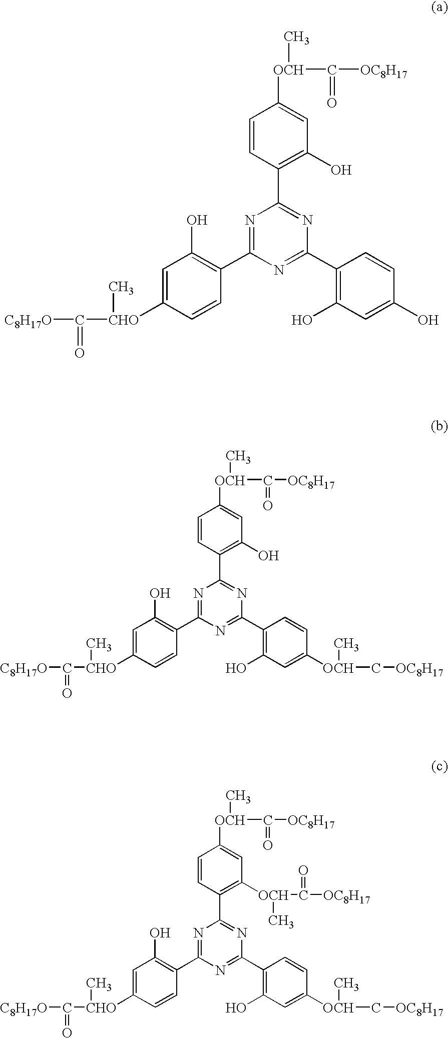

### (2) Preparation of a Sunlight Shielding Film

A hard coat layer having a thickness of 4 μm was formed on one face of a polyethylene terephthalate film having a thickness of 25 μm [manufactured by TORAY INDUSTRIES Inc; “LUMIRROR 25T-60”] as the substrate film in accordance with the process shown in the following.

Dipentaerythritol pentaacrylate as the active energy curable monomer of the radical polymerization type in an amount of 100 parts by mass, 5 parts by mass of “IRGACURE 127” [manufactured by CIBA SPECIALTY CHEMICALS Co., Ltd.] as the photopolymerization initiator, 500 parts by mass of a toluene dispersion of a tungsten oxide-based compound “YMF-01” [manufactured by SUMITOMO METAL MINING Co., Ltd.] as the agent for absorbing infrared light and 100 parts by mass of toluene were mixed. The obtained mixture was applied by using a bar coater to form a film having a thickness of 4 μm after being dried, and the formed film was irradiated with ultraviolet light from a high pressure mercury lamp.

Separately, a polyethylene terephthalate film having a thickness of 38 μm was coated with a silicone to obtain a release film on a surface of which a layer of a release agent having a thickness of 0.1 μm was disposed. The layer of release agent of the obtained release film was coated with the pressure sensitive adhesive composition prepared in (1) described above, and after a drying treatment at 100° C. for 1 minute, a pressure sensitive adhesive layer having a thickness of 15 μm was formed.

To the face of the substrate film opposite the face having the hard coat layer described above, the pressure sensitive adhesive layer with release film prepared above was laminated, and a sunlight shielding film was prepared.

The release film was removed from the sunlight shielding film prepared above, and the holding power, the transmittance of ultraviolet light and the yellowness index were measured. The results are shown in Table 1.

### Example 2

A sunlight shielding film was prepared in accordance with the same procedures as those conducted in Example 1 except that “TINUVIN 400” [manufactured by CIBA SPECIALTY CHEMICALS Co., Ltd.; a mono(hydroxyphenyl)triazine compound; the content of solid components: 100% by mass] was used as the agent for absorbing ultraviolet light, and the holding power, the transmittance of ultraviolet light and the yellowness index were measured. The results are shown in Table 1.

“TINUVIN 400” described above is a mixture of 2-[4-[(2-hydroxy-3-dodecyloxypropyl)oxy]-2-hydroxyphenyl]-4,6-(2,4-dimethylphenyl)-1,3,5-triazine expressed by the following formula (d) and 2-[4-[(2-hydroxy-3-tridecyloxypropyl)oxy)-2-hydroxyphenyl]-4,6-(2,4-dimethylphenyl)-1,3,5-triazine expressed by the following formula (e).

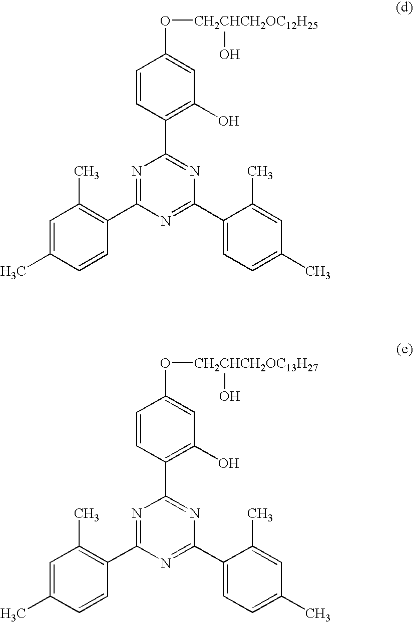

### Comparative Example 1

A sunlight shielding film was prepared in accordance with the same procedures as those conducted in Example 1 except that a benzotriazole-based compound [manufactured by SHIPRO KASEI KAISHA, Ltd.; “SEESORB 707”; 2-(2-hydroxy-4-octylphenyl)-2H-benzo-triazole”] was used as the agent for absorbing ultraviolet light, and the holding power, the transmittance of ultraviolet light and the yellowness index were measured. The results are shown in Table 1.

### Comparative Example 2

A sunlight shielding film was prepared in accordance with the same procedures as those conducted in Example 1 except that a cyanoacrylate-based compound [manufactured by BASF JAPAN, Ltd.; “UVINUL 3039”; ethyl 2-cyano-3,3-diphenylacrylate”] was used as the agent for absorbing ultraviolet light, and the holding power, the transmittance of ultraviolet light and the yellowness index were measured. The results are shown in Table 1.

TABLE 1

| | Type of | Holding | | Transmittance of | |
|---|---|---|---|---|---|
| | ultraviolet | power | | ultraviolet | |
| | light | 40° C. | 80° C. | light | Yellowness |
| | absorbent | (mm) | (mm) | (%) | index |
| Example 1 | tris(hydroxy- | 0.2 | 0.5 | 0.1 | 1.5 |
| | phenyl)triazine- | | | | |
| | based compound | | | | |
| Example 2 | mono(hydroxy- | 0.2 | 0.5 | 0.3 | 1.0 |
| | phenyl)triazine | | | | |
| | based compound | | | | |
| Comparative | benzotriazole- | 2.3 | dropped | 0.5 | 3.7 |
| Example 1 | based compound | | after 305 | | |
| | | | minutes | | |
| Comparative | cyanoacrylate- | 0.2 | 0.4 | 8.3 | 0.6 |
| Example 2 | based compound | | | | |

As shown by the results in Table 1, the sunlight shielding films of Examples 1 and 2 exhibited excellent holding powers at 40° C. and 80° C., transmittances smaller than 1% and yellowness index smaller than 2 and were both satisfactory.

In contrast, the sunlight shielding film of Comparative Examples 1 exhibited a poor holding power and an unsatisfactory yellowness index. The sunlight shielding film of Comparative Example 2 was not satisfactory since the film exhibited a great transmittance of ultraviolet light although the holding power was excellent.

### INDUSTRIAL APPLICABILITY

The sunlight shielding film of the present invention exhibits excellent ultraviolet light shielding property, suppresses peeling off when the film is attached to glass having curved surfaces, exhibits excellent scratch resistance and is advantageously used for attaching to window panes of buildings and window glasses of vehicles and, in particular, to window glasses of automobiles.

1-10. (canceled)

11. A pressure sensitive adhesive for sunlight shielding films which comprises a component (A) comprising a (meth)acrylic acid ester-based copolymer having a carboxyl group as a crosslinking functional group, a component (B) comprising a metal chelate-based crosslinking agent and a component (C) comprising a triazine-based agent for absorbing ultraviolet light.

12. The pressure sensitive adhesive for sunlight shielding films according to claim 11, wherein the component (B) is in an amount of 0.01 to 3 parts by mass based on 100 parts by mass of the component (A).

13. The pressure sensitive adhesive for sunlight shielding films according to claim 11, wherein the triazine-based agent for absorbing ultraviolet light of the component (C) is a compound which is a 1,3,5-triazine compound having three phenyl groups, which may have substituents, introduced at the 2-, 4- and 6-positions, and has a structure such that at least one of the three phenyl groups has a hydroxyl group at the 2-position and a hydroxyl group or an organic group bonded via an oxygen atom at the 4-position.

14. The pressure sensitive adhesive for sunlight shielding films according to claims 11, wherein the triazine-based agent for absorbing ultraviolet light of the component (C) is in an amount of 0.1 to 30 parts by mass based on 100 parts by mass of the component (A).

15. A sunlight shielding film which comprises a hard coat layer disposed on a first face of a substrate film and a pressure sensitive adhesive layer disposed on a second face of the substrate film, wherein said pressure sensitive adhesive layer is according to claim 11.

16. The sunlight shielding film according to claim 15, wherein the hard coat layer is formed of a material for forming a hard coat layer comprising a compound of an active energy ray curing type.

17. The sunlight shielding film according to claim 15, wherein the hard coat layer has a near infrared light shielding function.

18. The sunlight shielding film according to claim 15, which is attached to a glass having curved surfaces.

19. The sunlight shielding film according to claim 15, wherein the pressure sensitive adhesive comprises a triazine-based agent for absorbing ultraviolet light of the component (C) which is a 1,3,5-triazine compound having three phenyl groups, which may have substituents, introduced at the 2-,4- and 6-positions, and has a structure such that at least one of the three phenyl groups has a hydroxyl group at the 2-position and a hydroxyl group or an organic group bonded via an oxygen atom at the 4-position.
